(19) United States
(12) Patent Application Publication
(10) Pub. No.: US 2025/0337081 A1
(43) Pub. Date: Oct. 30, 2025

(54) BATTERY CARRIER ARRANGEMENT FOR AN ELECTRIC VEHICLE

(71) Applicant: BENTELER AUTOMOBILTECHNIK GMBH, Paderborn (DE)

(72) Inventors: Christian BUSE, Lichtenau (DE); Conrad FRISCHKORN, Paderborn (DE)

(21) Appl. No.: 19/189,266

(22) Filed: Apr. 25, 2025

(30) Foreign Application Priority Data
Apr. 26, 2024 (EP) 24172800.5

(51) Int. Cl. H01M 50/249; B60L 50/60; H01M 50/224

(52) U.S. Cl. CPC H01M 50/249; H01M 50/224; B60L 50/60; H01M 2220/20

(57) ABSTRACT

A battery carrier arrangement for an electric vehicle, including a battery tray, the battery tray including a base and a hood placed on the base with a hood base and side walls. The base is produced as a hot-formed and press-hardened component from a sheet steel blank, and the base has frame side walls which project laterally beyond the side walls of the battery tray in one piece and of the same material and which run obliquely upwards in sections in the vertical direction of the motor vehicle.

### RELATED APPLICATIONS

The present application claims priority of European Application Number 24172800.5 filed Apr. 26, 2024, the disclosure of which is hereby incorporated by reference herein in its entirety.

### FIELD

The present disclosure relates to a battery carrier arrangement for an electric vehicle.

### BACKGROUND

Battery trays are used in motor vehicles, i.e., for electromobility. Such battery trays are battery carriers or battery trays. These have a battery tray for accommodating drive batteries or traction batteries. The battery tray is closed with a lid.

Such a battery tray is located in the underfloor region of a motor vehicle. The battery tray extends over a large part of the underfloor region, such as the passenger compartment. Long sides of the battery tray are formed on the sides in the region of the sills. The battery tray is often connected to the vehicle body from below via these long sides, for example, in the region of the sills. Transverse sides are also formed at the head and rear, which extend across the vehicle width of such a motor vehicle.

From DE 10 2023 124 896 A1 an underfloor sheet metal is described which serves as an underride guard sheet metal and is arranged below such a battery tray.

### SUMMARY

The object of the present disclosure is to provide a battery carrier arrangement which is structurally simplified compared to aforementioned battery carrier arrangements, but at the same time has at least the same or increased crash safety and is cheaper to manufacture.

The aforementioned object is solved by a battery carrier arrangement according to the present disclosure.

The battery carrier arrangement is provided for an electric motor vehicle. The battery carrier arrangement has a battery box which includes a hood and a base. The hood has a tray-shaped configuration. However, when installed, the hood's opening points downwards in the vertical direction of the vehicle. The hood is thus closed by a base. The base itself also has a tray-shaped configuration. However, the base is open at the front and rear at its ends, i.e., in relation to the longitudinal direction of the vehicle, and has no side walls on the tray.

The base and side walls thus form the battery tray. The base itself is made from a sheet steel blank as a hot-formed and press-hardened component. For example, a hardenable steel alloy is used here. This is able to be, for example, a boron-manganese steel alloy, for example 22MnB5.

The battery box is thus formed from the hood, which is also referred to as a lid. The hood has a hood base or hood cover which is arranged facing upwards in the vertical direction of the vehicle when installed. The hood also has side walls. The side walls are designed all the way around. For this purpose, the hood is manufactured as a deep-drawn component or as a formed or folded component from a sheet metal blank, for example, a steel sheet blank. However, the hood is also able to be made from a light metal blank. The hood has an outwardly projecting circumferential flange at the end of its side walls. The flange is then coupled to the base. In at least one embodiment of the present disclosure, this coupling is achieved by screwing. In at least one embodiment of the present disclosure, a sealant is also incorporated between the flange and the base. When installed, the base is positioned at the bottom relative to the vertical direction of the vehicle and the hood is positioned above the base.

According to the present disclosure, the battery carrier arrangement is now characterized in that the base has frame side walls that project laterally beyond the side walls of the battery box in one piece and made of the same material. The frame side walls thus protrude laterally beyond the side walls in the transverse direction of the vehicle. In at least one embodiment of the present disclosure, the frame side walls are able to be an extension of the base. The frame side walls are made of one piece and the same material as the base, made from a sheet steel blank. The frame side walls also run obliquely upwards in the vertical direction of the vehicle, at least in sections.

According to the present disclosure, the base or the base sheet metal is thus at least partially tray-shaped. The section-wise configuration refers to the side walls or frame side walls. The side walls of the hood are then arranged on the base, i.e., within the base sheet metal, and thus form the battery box. In at least one embodiment of the present disclosure, these are end walls, which are arranged at the front and rear in the longitudinal direction of the vehicle. These are also lateral side walls, which are arranged on one side in the transverse direction of the vehicle. This creates a circumferential side wall that is placed on the base and coupled to the base. This creates a battery tray together with the base. The battery tray is then closed at its top, when installed, by the hood base. In at least one embodiment of the present disclosure, the hood base and the side walls are formed as a single piece and of the same material, as described above, as a formed component.

However, according to the present disclosure, the frame side walls then project laterally relative to the transverse direction of the motor vehicle and extend in sections obliquely upwards relative to the vertical direction of the vehicle. In at least one embodiment of the present disclosure, however, the base itself does not have a front and rear wall in relation to the longitudinal direction of the vehicle.

According to the present disclosure, the freedom of shaping of the base or base sheet metal is able to be simplified, which reduces production costs and material usage. Due to its high tensile strength of more than 1200 MPa, or more than 1350 MPa, the base sheet metal is also able to serve as an underride guard. An additional base sheet metal in the battery tray is therefore no longer necessary. This reduces the use of materials, the component weight and the manufacturing effort, compared to the aforementioned battery carrier arrangements.

The side walls are able to be placed on the base with a flange and then screwed in place, with the inclusion of a sealant. This allows for subsequent maintenance work to be performed, for example, to replace or repair the batteries located inside the battery box or to carry out other maintenance work. To do this, the screw connection between the hood and the base sheet metal are able to be loosened to access the inside of the battery box.

In order to improve the underride guard function, beads are able to be molded into the base. The beads are able to run in the longitudinal direction of the motor vehicle. In at least one embodiment of the present disclosure, the beads are formed so as to protrude downwards over the base in the vertical direction of the vehicle. The beads themselves are U-shaped in cross-section, with the cross-section lying in the transverse direction of the vehicle. The base itself is flat, with the beads then projecting beyond the flat base, such as downwards in relation to the vertical direction of the motor vehicle.

However, the beads are able to also run in the transverse direction of the motor vehicle. A combination of beads running in the longitudinal and transverse directions of the motor vehicle is also conceivable. In at least one embodiment of the present disclosure, beads are also able to be formed in such a way that, in installation situations, they are directed upwards in the vertical direction of the motor vehicle, and are therefore arranged so as to protrude into the interior of the battery box. Objects, such as battery modules, are then able to be arranged upright on the inwardly shaped beads within the battery box and stand on the inward-facing beads or respective contact surfaces. Likewise, cross braces in the battery box are able to rest on the beads.

Furthermore, the frame side walls are able to be formed as stiffening frames. An additional stiffening frame as an external component is able to therefore be omitted. For this purpose, the following alternative or complementary measures are able to be used, according to which, on the one hand, the lateral overhang of the base is formed into the sloping upward surface of the frame side wall as transverse beads or stiffening beads. In addition or alternatively, stiffening elements are able to be used between the frame side wall and the side wall, for example, these stiffening elements are able to be used as ribs or fins. In at least one embodiment of the present disclosure, these are spacer sheet metals. Deformation elements are also able to be used, wherein the deformation elements themselves are designed, for example, as hat profiles.

As a further stiffening measure, an upper frame sheet metal is placed on the frame side wall. In at least one embodiment of the present disclosure, a closed hollow profile is formed in the cross section between the upper frame sheet metal, the frame side wall and the side wall of the battery tray, which is located opposite on the inside. Thus, a lateral frame is formed. This lateral frame extends, for example, in the longitudinal direction of the vehicle, over the entire length of the battery tray or battery carrier. On the one hand, the frame functions as a kind of sill or stiffening frame. However, in the event of a side crash, for example, the frame is able to be formed as a crash box, thus, able to initially deform and dissipate crash energy, while at the same time initially protecting the battery tray located further inside from deformation.

In at least one embodiment of the present disclosure, an outwardly projecting flange is formed on a frame side wall. The outwardly projecting flange is able to be angled upwards again in the vertical direction of the vehicle. In at least one embodiment of the present disclosure, the outwardly projecting flange of the frame side wall is then used to couple, for example, via screw, the battery carrier to a motor vehicle from below. In at least one embodiment of the present disclosure, a distance is able to be formed between the flange and the upper frame sheet metal. Spacers, such as sleeves, are also able to be used. Coupling elements, for example, in the form of screw bolts, then penetrate the flange, the spacer and the upper frame sheet metal and are then coupled to a motor vehicle from below. The distance in turn creates a hollow cross-sectional profile, which forms an additional resistance component against bending in the form of stiffening.

Furthermore, the base is able to be made of a tailored blank. For example, the tailored blanks are able to be tailored welded blanks or tailored rolled blanks. Alternatively and additionally, the base is able to have tailored properties. For example, a reinforcement patch is able to be applied locally or higher strength properties are able to be set locally, for example, by a tailored tempering process.

In at least one embodiment of the present disclosure, the base or the base sheet metal is able to only partially be press-hardened, namely locally. In the press-hardened regions, this therefore has the previously mentioned strength values, which are above 1000 MPa. This is able to be the case, for example, in the region of the beads or in the region of the central base. In the region of the frame side walls, a lower strength, for example, a tensile strength Rm between 500 MPa and 850 MPa, is able to be formed, so that in the event of a side crash, a targeted deformation behavior occurs here according to the functional principle of a crash box. This means that crash energy is able to be dissipated into forming work.

### BRIEF DESCRIPTION OF THE DRAWINGS

Further advantages, features, and properties of the present disclosure are described in the following figures. These simplify the understanding of the present disclosure.

FIG. 1 shows a battery carrier arrangement according to at least one embodiment of the present disclosure,

FIG. 2 shows a perspective view from below of the battery carrier according to at least one embodiment of the present disclosure;

FIG. 3 shows a front view of the battery carrier arrangement according to at least one embodiment of the present disclosure;

FIG. 4 shows a perspective view from above of a base sheet metal according to at least one embodiment of the present disclosure,

FIG. 5 shows a perspective view from below of a base sheet metal according to at least one embodiment of the present disclosure,

FIG. 6 shows a front view of a base sheet metal according to at least one embodiment of the present disclosure, and

FIG. 7 shows a view of a base sheet metal from above according to at least one embodiment of the present disclosure.

### DETAILED DESCRIPTION

In the figures, the same reference numerals are used for same or similar components, although a repeated description or illustration is omitted for reasons of simplicity.

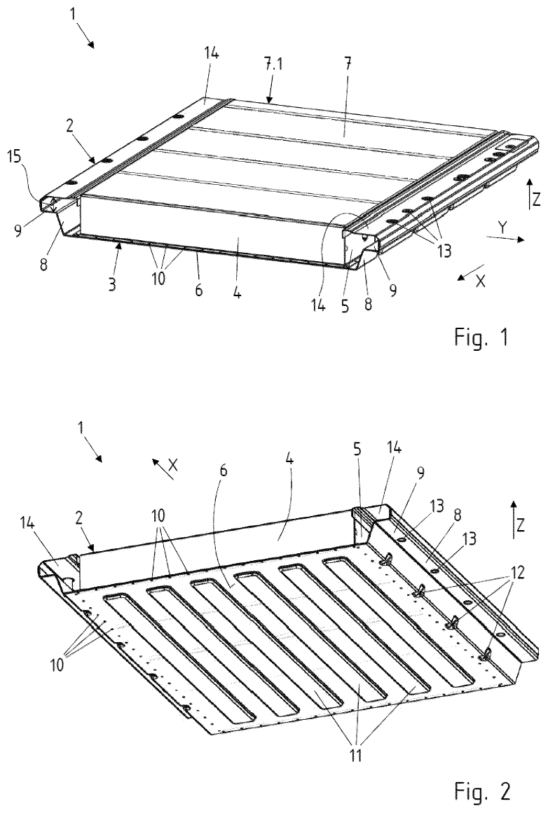

FIG. 1 shows a battery carrier arrangement 1 according to the present disclosure, including a battery carrier 2, also called a battery box. The battery carrier 2 has a base sheet metal 3 arranged at the bottom in the vertical direction Z of the motor vehicle. Furthermore, side walls 4, 5 are present. These are, on the one hand, transverse side walls 4, which are located at the front and rear in the longitudinal direction X of the vehicle, as well as a rear side wall (not shown in more detail), and, with respect to the transverse direction Y of the vehicle, longitudinal side walls 5, which extend in the longitudinal direction X of the vehicle and, with respect to the transverse direction Y of the vehicle, are each arranged laterally in the outer region. The transverse side walls 4 and longitudinal side walls 5, also called side walls, form an outer circumferential side wall. The base sheet metal 3 forms a base 6. This creates a battery box. The battery box then further includes a hood base 7, so that a hood 7.1 is inserted into the base sheet metal 3. The hood 7.1 points downwards with its opening, not shown in detail, in the vertical direction Z of the motor vehicle in the installation situation. The hood base 7 thus points upwards in the vertical direction Z of the motor vehicle. The hood 7.1 is further formed by transverse side walls 4 and longitudinal side walls 5. The transverse side walls 4 and the longitudinal side walls 5 are manufactured together with the hood base 7 in one piece and from the same material, for example, as a formed component, for example, as a folded component, thus the side walls are folded or bent relative to the hood base. Alternatively, the hood 7.1 is also able to be manufactured as a deep-drawn component or include several components.

According to the present disclosure, a respective frame side wall 8 is now formed projecting outwards in the transverse direction Y of the motor vehicle beyond the longitudinal side wall 5. The frame side wall 8 is a component of the base sheet metal 3. The frame side wall 8 is formed in one piece and made of the same material as the base 6. The frame side wall 8 initially projects beyond the longitudinal side wall 5 in the transverse direction Y of the motor vehicle, and thus the base 6 extends beyond the longitudinal side wall 5 in the transverse direction Y of the motor vehicle. Then, a part of the frame side wall 8 is formed obliquely upwards in the vertical direction Z of the motor vehicle.

In at least one embodiment of the present disclosure, a flange 9 is also provided projecting outwards, which in turn projects in the transverse direction Y of the motor vehicle from the frame side wall 8 in front of the part of the frame side wall 8 which runs obliquely upwards. The flange 9, the frame side wall 8, and the base 6 are made in one piece and from a single sheet metal blank.

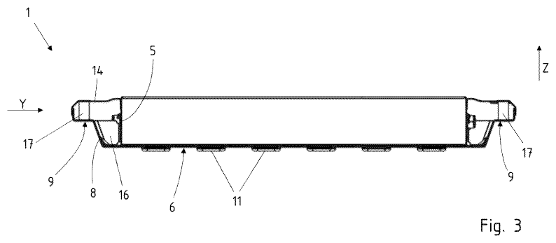

The longitudinal side walls 5 and transverse side walls 4 have a flange and are placed with the flange on the base 6, for example, via screw connections 10, as shown in FIG. 2, with the inclusion of a sealant.

Also in FIG. 2, which shows a perspective view from below of the battery carrier 2 according to the present disclosure, stiffening beads 11 or longitudinal beads are formed in the longitudinal direction X of the motor vehicle. These run in the longitudinal direction X of the motor vehicle. The stiffening beads 11 are designed to project downwards over the base 6 in relation to the vertical direction Z of the motor vehicle. The stiffening beads 11 extend only over a part of the base 6 in the longitudinal direction X of the motor vehicle, for example, less than 95%. This ensures the respective transverse side wall 4 are able to be coupled via spot welds. At the same time, the resulting battery box is designed to be correspondingly tight.

Furthermore, indentations/screws 12 or troughs or transverse beads are formed in the transition region of the frame side wall 8. The indentations 12 are formed between a horizontally extending portion of the frame side wall 8 and the part extending obliquely upwards. The indentations 12 stiffen the projecting part of the frame side wall 8, for example, with respect to the motor vehicle transverse direction Y and vertical direction Z. Furthermore, mounting openings 13 are provided so that the battery carrier arrangement 1 is able to be connected from below to a motor vehicle in the region of the sills by means of screw bolts which pass through the flange 9. The connection is able to be made, for example, to the sill itself or to additional longitudinal members.

Furthermore, an upper frame sheet metal 14 is provided. This upper frame sheet metal 14, in conjunction with the side wall and the frame side wall 8, forms a closed hollow profile in cross section. The hollow profile here is L-shaped. As a result, a stiffening frame is formed on the battery carrier 2. In the resulting distance 15 between flange 9 and frame sheet metal 8, spacer sleeves 17 or spacers, not shown in detail, are able to be arranged so that sufficient stability is provided when corresponding screw connections are used.

FIG. 3 shows a front view of the battery carrier arrangement 1 according to the present disclosure. An L-shaped hollow profile is formed in cross section between the upper frame sheet metal 14 and the frame side wall 8. In at least one embodiment of the present disclosure, spacer sheet metals 16 are able to be used here so that in the event of a side impact in the transverse direction Y of the vehicle, additional stiffening is provided between the frame side wall 8 and the longitudinal side wall 5. Furthermore, the spacer sleeves 17 are shown, so that the flange 9 is able to be penetrated by a screw bolt (not shown in detail) and then the battery carrier arrangement 1 shown is able to be screwed from below in the vertical direction Z of the motor vehicle to a motor vehicle (not shown in detail). Stiffening beads 11 project downwards over the base 6 in the vertical direction Z of the motor vehicle.

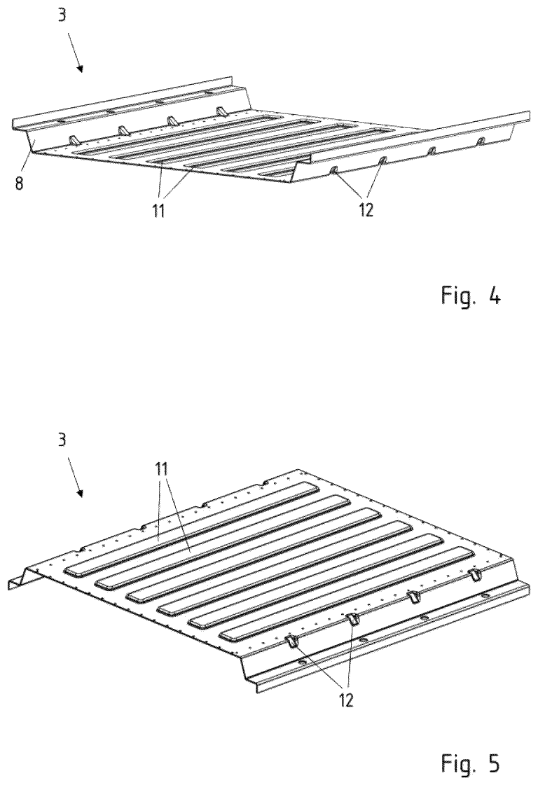

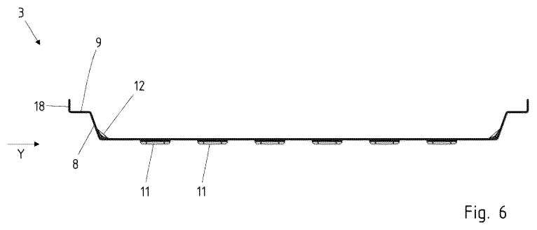

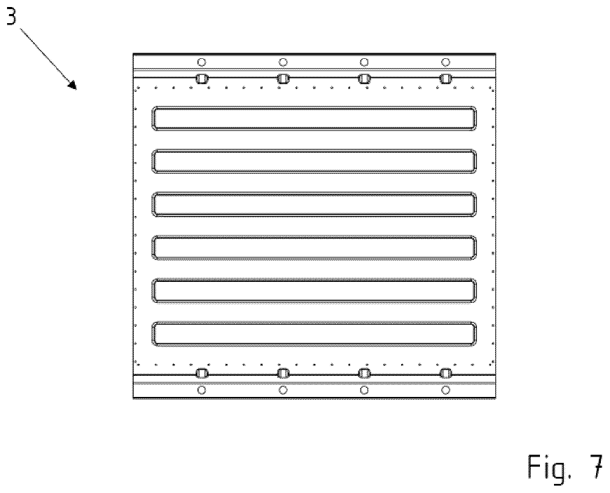

FIG. 4, FIG. 5, FIG. 6, and FIG. 7 show different views of the base sheet metal 3 according to the present disclosure. The base sheet metal 3 does not have a front and rear wall, but only the frame side wall 8 according to the present disclosure. The base sheet metal 3 is thus able to be produced in a simplified manner by a forming process, for example, via a deep-drawing process or a press-forming process. The base sheet metal 3 itself is configured in a U-shaped cross section. Opposite the flange 9 projecting laterally in the transverse direction Y of the motor vehicle, another vertical flange 18 is formed above. This is able to then be coupled to the upper frame sheet metal 14, which is not shown in detail.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes. substitutions and alterations can be made hereto without departing from the spirit and scope of the disclosure.

1-12. (canceled)

13. A battery carrier arrangement for an electric vehicle, the battery carrier arrangement comprising:
a battery tray comprising:
a base, and
a hood placed on the base, the hood having a hood base and a plurality of first side walls, wherein
the base is a hot-formed and press-hardened component from a sheet steel blank, and
the base has a plurality of second frame side walls which project laterally beyond the plurality of first side walls of the battery tray in one piece, the first side walls and the second frame side walls having the same material, and which run obliquely upwards in a vertical direction of the electric vehicle.

14. The battery carrier arrangement according to claim 13, further comprising a plurality of beads in the base, wherein
the plurality of beads run in a longitudinal direction of the electric vehicle, in such a way that the base is an underride guard sheet metal.

15. The battery carrier arrangement according to claim 13, further comprising a plurality of transverse beads in at least one of:
a transition region from the base to the plurality of second frame side walls, or
a transition region from the plurality of second frame side walls to a flange which extends from the plurality of second frame side walls.

16. The battery carrier arrangement according to claim 13, wherein the plurality of first side walls of the hood are coupled to the base.

17. The battery carrier arrangement according to claim 13, further comprising an upper frame sheet metal on the plurality of second frame side walls, wherein
the upper frame sheet metal is coupled to the plurality of first side walls in such a way that a hollow profile with a closed cross section is obtained between the plurality of first side walls, the plurality of second frame side walls, and the upper frame sheet metal.

18. The battery carrier arrangement according to claim 13, further comprising spacers or deformation elements inserted between the plurality of second frame side walls and a longitudinal side wall of the plurality of first side walls.

19. The battery carrier arrangement according to claim 13, further comprising an outwardly projecting flange on the plurality of second frame side walls.

20. The battery carrier arrangement according to claim 17, wherein
a distance is formed between the upper frame sheet metal and a flange which extends from the plurality of second frame side walls,
a plurality of spacer sleeves are inserted in such a way that screw connections are arranged so as to pass through the flange, the plurality of spacer sleeves, and the upper frame sheet metal, to connect the battery carrier to the electric vehicle.

21. The battery carrier arrangement according to claim 13, wherein the base comprises a tailored blank or has tailored properties.

22. The battery carrier arrangement according to claim 13, wherein the base has at least in sections a tensile strength Rm of more than 1200 MPa.

23. The battery carrier arrangement according to claim 13, wherein
the base has a higher tensile strength, and
at least one of the plurality of second frame side walls or a flange which extends from the plurality of second frame side walls has a tensile strength lower than the base.

24. The battery carrier arrangement according to claim 14, wherein the plurality of beads comprise inwardly projecting beads and outwardly projecting beads.

25. The battery carrier arrangement according to claim 13, wherein the base has at least in sections a tensile strength Rm of more than 1350 MPa.

26. The battery carrier arrangement according to claim 23, wherein the tensile strength in at least one of the plurality of second frame side walls or the flange is 550 MPa to 1000 MPa.

27. The battery carrier arrangement according to claim 23, wherein the tensile strength in at least one of the plurality of second frame side walls or the flange is 550 MPa to 850 MPa.
